(19) United States
(12) Patent Application Publication
(10) Pub. No.: US 2025/0150451 A1
(43) Pub. Date: May 8, 2025

(54) CENTRALIZED JUST-IN-TIME MULTI-FACTOR AUTHENTICATION FOR CONTROL OF ACCOUNT LOGON RIGHTS

(71) Applicant: Zero Networks Ltd., Tel Aviv (IL)

(72) Inventors: Benny LAKUNISHOK, Tel Aviv (IL); Amir FRANKEL, Tel Aviv (IL); Sagie DULCE, Cascais (PT)

(21) Appl. No.: 18/386,374

(22) Filed: Nov. 2, 2023

(51) Int. Cl. H04L 9/40

(52) U.S. Cl. CPC H04L 63/0846; H04L 63/0861; H04L 2463/082

(57) ABSTRACT

There is provided a system of controlling account logon rights on one or more computer systems based on multifactor authentication (MFA), the system comprising a processing circuitry (PC) adapted to: configure respective logon rights control facilities of the one or more computer systems, to, at least, deny logon rights of a first account in, at least, a first logon type; responsive to detecting, in a logon logging facility of a first computer system of the one or more computer systems, an event of denying logon rights to the first account by the logon rights control facility, initiate a sequence of authentication of the first user; responsive to successful completion of the sequence of authentication, configure the logon rights control facility of the first computer system to remove denial of logon rights to the first account in, at least, the first logon type, thereby performing an MFA process

### TECHNICAL FIELD

The presently disclosed subject matter relates to authorization of users accessing computing resources, and in particular to implementation of systems for control of multiple computer servers and workloads.

### BACKGROUND

Problems of implementation in systems of managing account logon rights have been recognized in the conventional art and various techniques have been developed to provide solutions.

Accounts Logon Rights refers to the control of who or what is authorized to log on to one or more servers and how they can log on. Some accounts are authorized to have more access than others

Multi-factor authentication (MFA) refers to authentication methods in which the identity of a user is confirmed and the user is granted access at the application layer to some resource only after successfully presenting at least two factors of evidence to an authentication mechanism. For example, an MFA for an Internet website might include a username and password being entered into the website, followed by a text message being sent to a smartphone associated with the user whose username was submitted to the website.

### GENERAL DESCRIPTION

According to one aspect of the presently disclosed subject matter there is provided a system of controlling account logon rights on one or more computer systems based on multifactor authentication, the system comprising a processing circuitry (PC), the PC being operably connectable to the one or more computer systems,
the PC being adapted to:
a) configure respective logon rights control facilities of the one or more computer systems, to, at least, deny logon rights of a first account in, at least, a first logon type;
b) responsive to detecting, in a logon logging facility of a first computer system of the one or more computer systems, an event of denying logon rights to the first account by the logon rights control facility,
   wherein the detected event indicates an attempted logon to the first account, by a first user, using the first logon type:
      initiate a sequence of authentication of the first user,
      wherein the sequence of authentication utilizes a factor of authentication that is different from factors of authentication used in a logon attempt associated with the detected denying logon rights, thereby performing a multifactor authentication process,;
c) responsive to successful completion of the sequence of authentication, configure the logon rights control facility of the first computer system to remove denial of logon rights to the first account in, at least, the first logon type.

In addition to the above features, the system according to this aspect of the presently disclosed subject matter can comprise one or more of features (i) to (viii) listed below, in any desired combination or permutation which is technically possible:
(i) the PC is further adapted to:
   responsive to expiration of an access timer, configure the logon rights control facility of the first server, so as to, at least, deny logon rights of the first account on the first server in, at least, the first logon type
(ii) the PC performs the configuring by, at least, utilizing a software agent resident on the first computer system.
(iii) the PC performs the configuring by, at least, executing a powershell command on the first computer system.
(iv) the PC performs the configuring at least partially in response to a policy rule.
(v) the PC performs the configuring at least partially in response to a real-time alert.
(vi) the performed sequence of authentication utilizes a mobile device associated with the first user.
(vii) performed sequence of authentication requires the first user to enter a code to the mobile device.
(viii) the performed sequence of authentication requires a fingerprint of the first user.

According to another aspect of the presently disclosed subject matter there is provided a processing circuitry-based method of controlling account logon rights of one or more computer systems based on multifactor authentication, the method comprising:
a) configuring respective logon rights control facilities of the one or more computer systems, to, at least, deny logon rights of a first account in, at least, a first logon rights type;
b) responsive to detecting, in a logon logging facility of a first computer system of the one or more computer systems, an event of denying logon rights to the first account by the logon rights control facility,
   wherein the detected event indicates an attempted logon to the first account, by a first user, using the first logon rights type:
      initiating a sequence of authentication of the first user,
      wherein the sequence of authentication utilizes a factor of authentication that is different from factors of authentication used in a logon attempt associated with the detected denying logon rights, thereby performing a multifactor authentication process; and
c) responsive to successful completion of the sequence of authentication, configuring the logon rights control facility of the first computer system to remove denial of logon rights to the first account in, at least, the first logon rights type.

This aspect of the disclosed subject matter can further optionally comprise one or more of features (i) to (viii) listed above with respect to the system, mutatis mutandis, in any desired combination or permutation which is technically possible.

According to another aspect of the presently disclosed subject matter there is provided a computer program product comprising a computer readable non-transitory storage medium containing program instructions, which program instructions when read by a processor, cause the processing circuitry to perform a method of controlling account logon rights of one or more computer systems based on multifactor authentication, the method comprising:
a) configuring respective logon rights control facilities of the one or more computer systems, to, at least, deny logon rights of a first account in, at least, a first logon rights type;
b) responsive to detecting, in a logon logging facility of a first computer system of the one or more computer systems, an event of denying logon rights to the first account by the logon rights control facility,
   wherein the detected event indicates an attempted logon to the first account, by a first user, using the first logon rights type:
      initiating a sequence of authentication of the first user,
      wherein the sequence of authentication utilizes a factor of authentication that is different from factors of authentication used in a logon attempt associated with the detected denying logon rights, systems thereby performing a multifactor authentication process,; and
c) responsive to successful completion of the sequence of authentication, configuring the logon rights control facility of the first computer system to remove denial of logon rights to the first account in, at least, the first logon rights type.

This aspect of the disclosed subject matter can further optionally comprise one or more of features (i) to (viii) listed above with respect to the system, mutatis mutandis, in any desired combination or permutation which is technically possible.

In current IT environments, the risk tied to privileged and service account logins presents a significant threat.

Admin accounts, possessing high-level access to sensitive servers, can log in from less secure machines, inadvertently exposing their credentials to potential attackers.

Service account credentials, if stolen, can be utilized by attackers on any machine within the network; this vulnerability allows unauthorized users to move laterally within the network, intensifying the potential for extensive access and damage.

Accordingly, among the advantages of some embodiments of the presently disclosed subject matter is the restricting of logon capabilities for each account based on necessity and on designated privileges.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1, illustrates an example deployment of a resource access control system in a server environment, in accordance with some embodiments of the presently disclosed subject matter;

FIG. 2 illustrates a message exchange sequence of an example operation of controlling logon rights of one or more servers, in accordance with some embodiments of the presently disclosed subject matter;

FIG. 3 illustrates a block diagram of an example resource access control system and controlled server, in accordance with some embodiments of the presently disclosed subject matter;

FIG. 4 illustrates an example multifactor authentication (MFA) policy database, in accordance with some embodiments of the presently disclosed subject matter;

FIG. 5 illustrates an example logon request log, in accordance with some embodiments of the presently disclosed subject matter;

FIG. 6 illustrates a flow diagram of example method of initializing a server to facilitate multifactor user authentication based on static or dynamically-updated policy, in accordance with some embodiments of the presently disclosed subject matter; and

FIG. 7 illustrates a flow diagram of example method of utilizing multifactor user authentication, based on static or dynamically-updated external policy, to control server logon rights in real-time, in accordance with some embodiments of the presently disclosed subject matter.

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “comparing”, “encrypting”, “decrypting”, “determining”, “calculating”, “receiving”, “providing”, “obtaining”, “emulating” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, the processor, mitigation unit, and inspection unit therein disclosed in the present application.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

Embodiments of the presently disclosed subject matter are not described with reference to any particular programming language. It will be appreciated that a variety of programming languages may be used to implement the teachings of the presently disclosed subject matter as described herein.

Accounts Logon Rights refers to the authorization process which grants logon rights to certain user accounts or service accounts on one or more servers. Some accounts are authorized to have more access than others, and therefore more stringent security measures, such as strong authentication mechanisms, access controls, monitoring, and auditing, may be required to prevent unauthorized use and potential security breaches of such accounts.

Some embodiments of the presently disclosed matter dynamically manage accounts logon rights on a group of servers according to centralized policy criteria. Some such embodiments are distinguished from other systems which manage server functions such as network connectivity. Among the advantages of some embodiments of the presently disclosed subject matter are: protection of specific accounts on specific servers account to possibly-dynamic centralized policies, and protection levels that vary according to the type of access being requested.

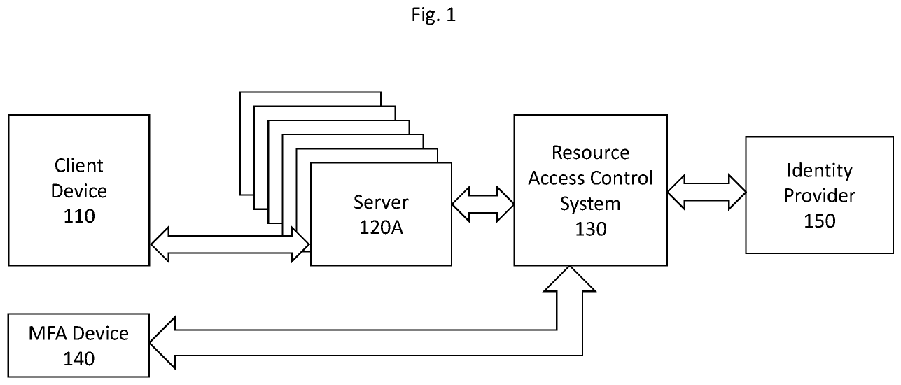

Attention is directed to FIG. 1, which illustrates an example deployment of a resource access control system in a server environment, in accordance with some embodiments of the presently disclosed subject matter.

Client device 110 can be a suitable kind of computing device utilizable for accessing server 120A over a communication medium. By way of non-limiting example, client device 110 can be a personal computer, laptop, tablet computer, smartphone etc.

Server 120A can be any kind of computer system. By way of non-limiting example: server 120A can be a physical server, cloud server, smartphone, tablet computing device, virtual machine, container etc. In some examples, server 120A can be a computer system that of a type that is typically regarded as a “client” system (e.g. a desktop computer that is typically used by a single user). Deployments can include many different servers that are simultaneously managed by resource access control system 130.

Client device 110 can be operably connected (for example via a console connection, a local area network, the internet etc.) to server 120, to enable logon.

Resource access control system 130 can be operably connected to server 120 (e.g. via a local network or cloud network connection), and can control its account logon rights.

Resource access control system 130 can be operably connected to identity provider 150 (for example via the internet).

Resource access control system 130 can communicate with an MFA device 140 such as a cellphone etc. via e.g. a cellular connection. In some embodiments, resource access control system 130 communicates—in certain circumstances—with identity provider 150 thereby causing identity provider 150 to perform an additional authentication of a user via MFA device 140. In some other embodiments, resource access control system 130 initiates the additional authentication using a different mechanism.

As discussed in detail hereinbelow, resource access control system 130 can control account logon rights on servers such as server 120A—for example: by blocking a particular mode of logon to a particular account until an additional authentication sequence has successfully completed.

It is noted that the teachings of the presently disclosed subject matter are not bound by the entities described with reference to FIG. 1. Equivalent and/or modified functionality can be consolidated or divided in another manner and can be implemented in any appropriate combination of software with firmware and/or hardware and executed on a suitable device. The Resource Access Control System can be a standalone network entity, or integrated, fully or partly, with other entities. It will be clear to one skilled in the art how a control system can be employed in other embodiments.

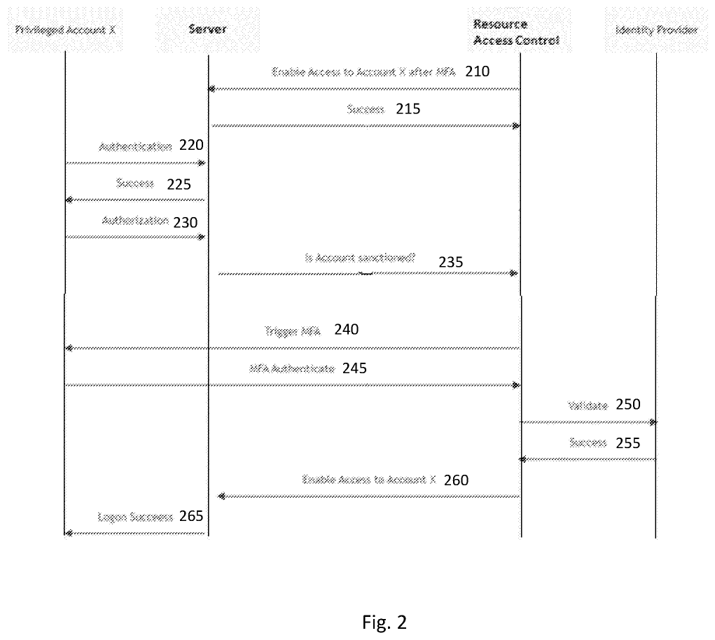

FIG. 2 illustrates a message exchange sequence of an example operation of controlling logon rights of one or more servers, in accordance with some embodiments of the presently disclosed subject matter.

The resource access control system 130 can signal to server 120A to disable account logon rights (to be enabled 210 after MFA)

The server can signal 215 success to the remote access control system.

Next, a user of a privileged account can attempt authentication 220 to server 120A. the server can signal 225 success. The server then evaluates 230 authorization of the privileged user i.e. it determines the account logon rights of the user.

If the account is sanctioned 235 i.e. the server has been configured to deny logon rights, then logon rights are denied. The server 120A sends a message (either on its own or in response to a query) indicating 235 the logon rights denial (and its details) to resource access control system 130.

Resource access control system 130 can then evaluate policy for the logon, and trigger 240 multifactor authentication (MFA) of the privileged account user. Resource access control system 130 can then receive 245 MFA data transmitted by the user, validate 250 the authentication data at the identity provider 150, and receive 255 a positive response from the identity provider 150.

Finally, the privileged user is then granted logon success 265.

After the successful authentication, resource access control system 130 can communicate with server 120A to enable 260 the logon rights of the account.

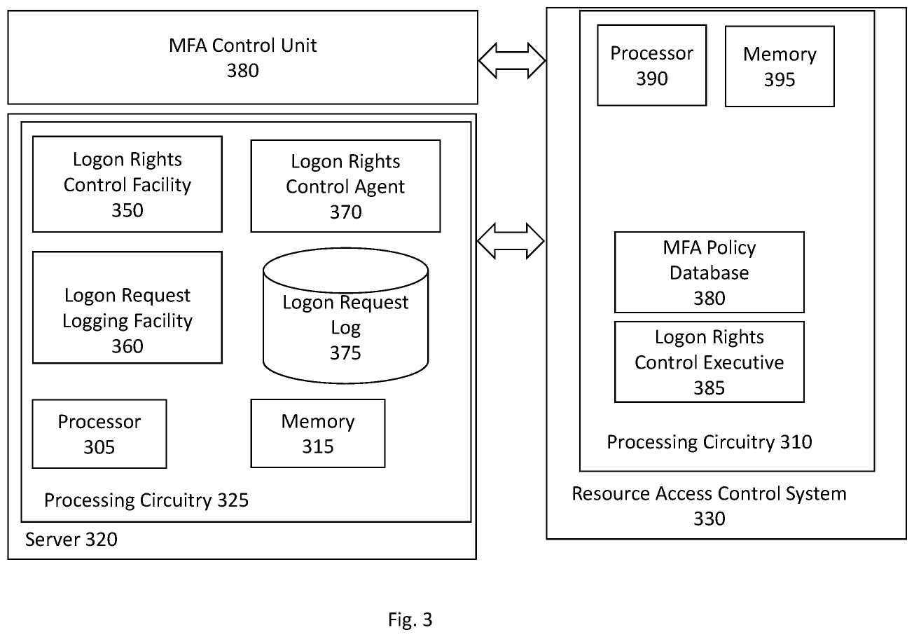

FIG. 3 illustrates a block diagram of an example resource access control system and controlled server, in accordance with some embodiments of the presently disclosed subject matter.

Resource access control system 330 can include processing circuitry 310. Processing circuitry 310 can be a computer system which manages account logon rights to one or more servers 320, according to e.g. a static or dynamically-updating policy.

Resource access control system 330 can be operably connected to server 320 e.g. by a network connection such as ethernet.

Server 320 can include processing circuitry 310, which can include processor 390 and memory 315.

Processor 305 390 can be a suitable hardware-based electronic device with data processing capabilities, such as, for example, a general purpose processor, digital signal processor (DSP), a specialized Application Specific Integrated Circuit (ASIC), one or more cores in a multicore processor, etc. Processor 305 390 can also consist, for example, of multiple processors, multiple ASICs, virtual processors, combinations thereof etc.

Memory 315 395 can be, for example, a suitable kind of volatile and/or non-volatile storage, and can include, for example, a single physical memory component or a plurality of physical memory components. Memory 315 395 can also include virtual memory. Memory 315 395 can be configured to, for example, store various data used in computation.

Processing circuitry 310 can be configured to execute several functional modules in accordance with computer-readable instructions implemented on a non-transitory computer-readable storage medium. Such functional modules are referred to hereinafter as comprised in the processing circuitry. These modules can include, for example, resource control access executive 385 and MFA policy database 380.

Processing circuitry 325 can be configured to execute several functional modules in accordance with computer-readable instructions implemented on a non-transitory computer-readable storage medium. Such functional modules are referred to hereinafter as comprised in the processing circuitry. These modules can include, for example, logon rights control facility 350, logon rights control agent 370, and logon request logging facility 360, and logon request log 375.

Server 320 can include logon rights control facility 350. Logon rights control facility 350 can be e.g. a facility in the operating system that controls authorization of certain types of access (e.g. types of logon) to particular accounts. In some examples, logon rights control facility 350 can be or can include Microsoft™ Authorization application programming interfaces (APIs) (e.g. LsaRemoveAccountRights and LsaAddAccountRights₎

Server 320 can include a logon rights control agent 370. Logon rights control agent 370 can be a software component that receives instructions from resource access control system 330, and can perform control operations in server 320. In some embodiments, logon rights control agent 370 can be an operating system native powershell utility. In some embodiments, logon rights control agent 370 can be a custom application.

Server 320 can include logon request logging facility 360. Logon request logging facility 360 can be a software module which logs data to logon request log 375 in response to access events, as will described in more detail hereinbelow.

Resource access control system 330 can include multifactor authentication (MFA) policy database 380. MFA policy database 380 can be a table that describes current policies regarding accounts and associated requirements pertaining to multifactor authentication, as described in detail below.

Resource access control system 330 can include logon rights control executive 385. Logon rights control executive 385 can communicate with server 320 to implement security and multifactor authentication policy that is in accordance with MFA policy database 380, as described in detail below.

MFA control unit 380 can be a system which controls multifactor authentication of users of server 320. In some embodiments, MFA control unit 380 initiates an authentication process on the client device (e.g. initializing a web browser and directing it to an authentication screen. In some embodiments, MFA control unit 380 communicates with an authentication application that is resident on a cellphone associated with a user who is attempting to access server 320. In some other embodiments, MFA control unit 380 authenticates a user via a different mechanism.

In some embodiments, MFA control unit 380 receives authentication data from client device 110.

In some embodiments, MFA control unit 380 receives authentication data from MFA device 140.

In some embodiments, MFA control unit 380 initiates authentication which utilizes a factor of authentication which is not identical to the factor of authentication utilized in initial logon (attempt of access).

In some embodiments, MFA control unit 380 receives the authentication data in an encrypted format that is decryptable by identity provider 150.

In some embodiments, MFA control unit 380 transmits received authentication data to identity provider 150 and receives success/failure indication from identity provider 150. In some embodiments, MFA control unit 380 using a different suitable mechanism.

It is noted that the teachings of the presently disclosed subject matter are not bound by the resource access control system and server described with reference to FIG. 3. Equivalent and/or modified functionality can be consolidated or divided in another manner and can be implemented in any appropriate combination of software with firmware and/or hardware and executed on a suitable device. The resource access control system can be a standalone network entity, or integrated, fully or partly, with other entities. It will be clear to one skilled in the art how a radar system can be employed in other embodiments.

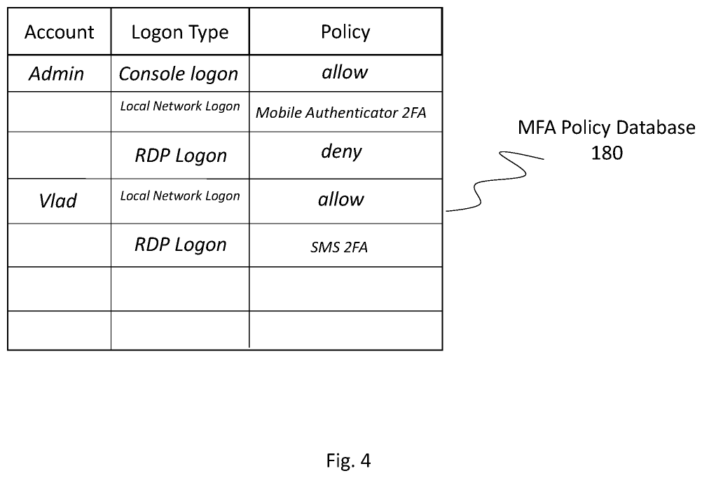

FIG. 4 illustrates an example MFA policy database, in accordance with some embodiments of the presently disclosed subject matter.

In some examples, MFA policy database 380 can be a logical table with—for example—3 logical columns:
Account name: e.g. a character string indicating an account name (which in some examples is identical with a user name)
Logon type: denotes a particular logon type that is being managed for the particular account e.g. console logon, local network logon, remote desktop protocol (RDP) logon
Policy: a value that indicates a particular policy to be applied to attempts to access the server in the indicated logon type. In some examples, possible policies include:
   “Allow”: i.e. do not perform additional control beyond what is already performed on the server
   “Deny”: i.e. deny logon rights
   “MFA”: i.e. perform an one or more additional authentications sequences before enabling logon rights.

In the example shown in FIG. 4, policies are presented for two accounts: “Admin” and “Vlad”

For the “Admin” account, physical console logon is allowed (i.e. there is no control beyond what is configured on the server). Local network logon requires two-factor authentication via a “mobile authenticator” app. Access via RDP logon is always denied.

For the “Vlad” account, local network logon is allowed. RDP logon requires two-factor authentication via entry of a code received over SMS.

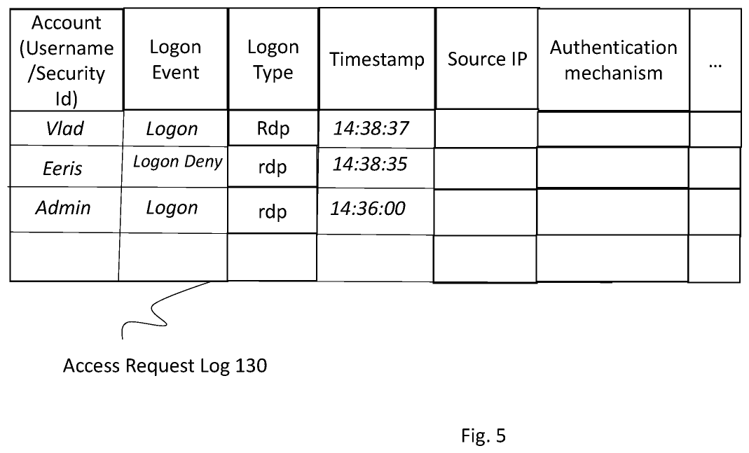

FIG. 5 illustrates an example logon request log, in accordance with some embodiments of the presently disclosed subject matter.

In some examples, logon request log 375 can be a logical table with a number of logical columns such as:
Account name: e.g. a character string indicating an account name (which in some examples is identical with a user name. In a Microsoft™ environment, the access log can index events by a Security Identifier.
Logon event: e.g. logon success, logon rights denial
Logon type: denotes a particular logon type that is associated with a specific log event i.e. the logon type utilized in the logon or logon attempt
Timestamp
Additional details such as client IP address etc.

In the example shown in FIG. 5, policies three logged events are shown:
In the most recent event, a user logged on to account “Vlad” via RDP at 14:38:37 on a particular date
In the second most recent event, a failed attempt to log on to account “Eeris” occurred via RDP at 14:38:35
In the third most recent event, a user logged on to account “Admin” via RDP at 14:36:00

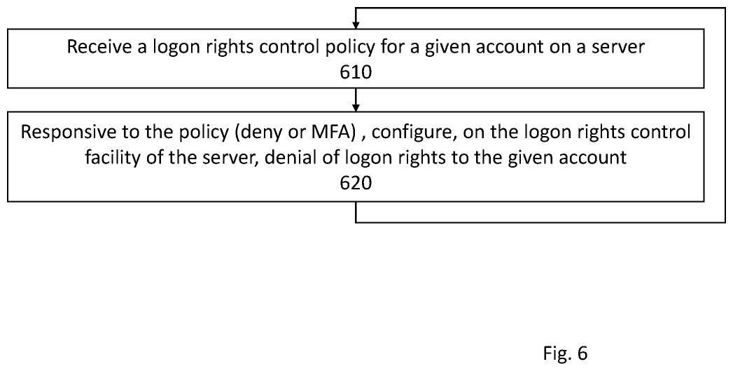

FIG. 6 illustrates a flow diagram of example method of initializing a server to facilitate multifactor user authentication based on static or dynamically-updated policy, in accordance with some embodiments of the presently disclosed subject matter.

Processing circuitry 310 (e.g. logon rights control executive 385) can receive 610 an account permission control policy for a given account on a given server.

By way of non-limiting example, during initialization of resource access control system 330, processing circuitry 310 (e.g. logon rights control executive 385) can retrieve each entry of MFA policy database 180 (each entry containing, for example, a policy structure such as shown above with reference to FIG. 4).

By way of further non-limiting example, processing circuitry 310 (e.g. logon rights control executive 385) can retrieve updated entries of MFA policy database 380 periodically, or in response to a notification of the update.

By way of further non-limiting example, processing circuitry 310 (e.g. logon rights control executive 385) can retrieve MFA policy data from a remote server (not shown) e.g. in response to a specific real-time security alert.

Processing circuitry 310 (e.g. logon rights control executive 385) can next-for example: when indicated by the retrieved policy-configure 620 denial of logon rights to the given account on the logon rights control facility of the server,

By way of non-limiting example: if the policy requires multifactor authentication, processing circuitry 310 (e.g. logon rights control executive 385) can communicate with server 320 (for example: logon rights control agent 370) and instruct it to configure logon rights control facility 350 to deny logon rights to the account for the particular logon type.

It is noted that the teachings of the presently disclosed subject matter are not bound by the flow chart illustrated in FIG. 4. It is also noted that whilst the flow chart is described with reference to elements of the system of FIG. 1 or 3, this is by no means binding, and the operations can be performed by elements other than those described herein.

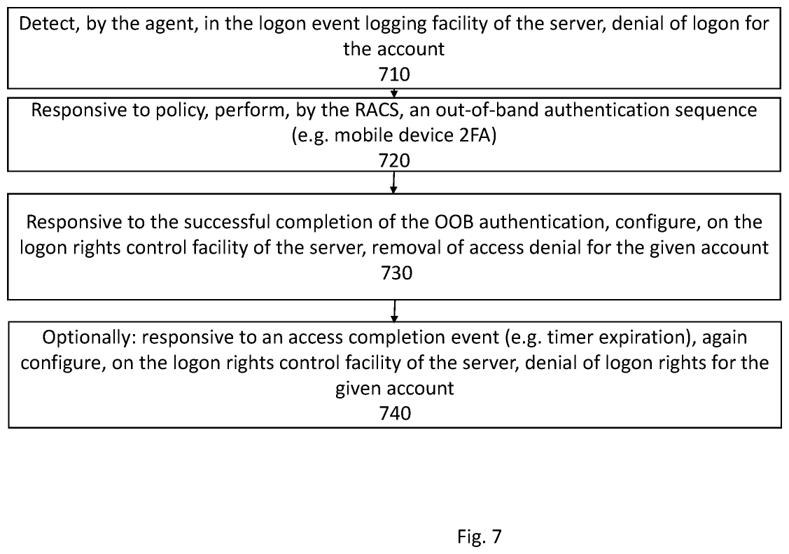

FIG. 7 illustrates a flow diagram of example method of utilizing multifactor user authentication, based on static or dynamically-updated external policy, to control server logon rights in real-time, in accordance with some embodiments of the presently disclosed subject matter.

Processing circuitry 310 (e.g. logon rights control executive 385) can detect 710, e.g. in the logon request log 375 of the server, an event of denial of logon rights for a particular account.

Processing circuitry 310 (e.g. logon rights control executive 385) can perform the detection of the denial of logon rights event by, for example, transmitting a request to logon rights control agent 370 in server 320. Processing circuitry 310 (e.g. logon rights control executive 385) can then receive a response from logon rights control agent 370 in server 320 indicating details of recent logon attempts which were denied due to the configuration of the account in logon rights control facility 350.

In some examples, processing circuitry 310 (e.g. logon rights control executive 385) the response received can include the logon type of the logon request that was denied.

In some embodiments, logon rights control agent 370 in server 320 can send notifications of recent denied logon attempts to processing circuitry 310 (e.g. logon rights control executive 385) without a preceding request.

Processing circuitry 310 (e.g. logon rights control executive 385) can next, responsive to a static or dynamically-updated policy for the account (e.g as illustrated above with reference to FIG. 4) indicating a requirement for additional authentication, initiate an out-of-band authentication sequence of the user associated with the account.

By way of non-limiting example, processing circuitry 310 (e.g. logon rights control executive 385) can perform the initiation of the out-of-band authentication sequence by communicating the indicated authentication method and associated data to MFA control unit 380. MFA control unit 380 can then perform the authentication.

In some examples, processing circuitry 310 (e.g. MFA control unit 380), initiates authentication that utilizes a cellphone number or email address that is associated with the user who uses the particular account. In some examples, processing circuitry 310 (e.g. MFA control unit 380), specifies utilization of a particular cellphone application such as a dedicated authentication app. In some other examples, processing circuitry 310 (e.g. MFA control unit 380), specifies utilization of short message service (SMS) or some other method.

In some examples, policy can specify multiple additional authentications. In such cases, processing circuitry 310 (e.g. logon rights control executive 385) can initiate multiple out-of-band authentications and receive the respective authentication results.

Processing circuitry 310 (e.g. logon rights control executive 385) can, responsive to the successful completion(s) of the out-of-band authentication(s) (e.g. as received from identity provider 150), configure 730, on the logon rights control facility 350 of server 320, removal of logon rights denial for the given account. In some examples, processing circuitry 310 (e.g. logon rights control executive 385) configures removal of logon rights denial for a particular account in one or more logon types.

Processing circuitry 310 (e.g. logon rights control executive 385) can perform the removal of logon rights denial by, for example, transmitting a request and receiving a response from logon rights control agent 370 in server 320.

Processing circuitry 310 (e.g. logon rights control executive 385) can next, responsive to a logon completion event (such as a timer expiration, or a user logoff event), again configure, on the logon rights control facility 350 of server 320, denial of logon rights for the particular account.

It is noted that the teachings of the presently disclosed subject matter are not bound by the flow chart illustrated in FIG. 7, the illustrated operations can occur out of the illustrated order. It is also noted that whilst the flow chart is described with reference to elements of the system of FIG. 1 or 3, this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A system of controlling account logon rights on one or more computer systems based on multifactor authentication, the system comprising a processing circuitry (PC), the PC being operably connectable to the one or more computer systems,
the PC being adapted to:
a) configure respective logon rights control facilities of the one or more computer systems, to, at least, deny logon rights of a first account in, at least, a first logon type;
b) responsive to detecting, in a logon logging facility of a first computer system of the one or more computer systems, an event of denying logon rights to the first account by the logon rights control facility,
wherein the detected event indicates an attempted logon to the first account, by a first user, using the first logon type:
initiate a sequence of authentication of the first user,
wherein the sequence of authentication utilizes a factor of authentication that is different from factors of authentication used in a logon attempt associated with the detected denying logon rights,
thereby performing a multifactor authentication process; and
c) responsive to successful completion of the sequence of authentication, configure the logon rights control facility of the first computer system to remove denial of logon rights to the first account in, at least, the first logon type.

2. The system of claim 1, wherein the PC is further adapted to:
d) responsive to expiration of a timer, configure the logon rights control facility of the first computer system, so as to, at least, deny logon rights of the first account on the first computer system in, at least, the first logon type.

3. The system of claim 1, wherein the PC performs the configuring by, at least, utilizing a software agent resident on the first computer system.

4. The system of claim 1, wherein the PC performs the configuring by, at least, executing a powershell command on the first computer system.

5. The system of claim 1, wherein the PC performs the configuring at least partially in response to a policy rule.

6. The system of claim 1, wherein the PC performs the configuring at least partially in response to a real-time alert.

7. The system of claim 1, wherein the performed sequence of authentication utilizes a mobile device associated with the first user.

8. The system of claim 5, wherein the performed sequence of authentication requires the first user to enter a code to the mobile device.

9. The system of claim 5, wherein the performed sequence of authentication requires a fingerprint of the first user.

10. A processing circuitry-based method of controlling account logon rights of one or more computer systems based on multifactor authentication, the method comprising:
a) configuring respective logon rights control facilities of the one or more computer systems, to, at least, deny logon rights of a first account in, at least, a first logon type;
b) responsive to detecting, in a logon logging facility of a first computer systems of the one or more computer systems, an event of denying logon rights to the first account by the logon rights control facility,
wherein the detected event indicates an attempted logon to the first account, by a first user, using the first logon type:
initiating a sequence of authentication of the first user,
wherein the sequence of authentication utilizes a factor of authentication that is different from factors of authentication used in a logon attempt associated with the detected denying logon rights, thereby performing a multifactor process; and
c) responsive to successful completion of the sequence of authentication, configuring the logon rights control facility of the first computer system to remove denial of logon rights to the first account in, at least, the first logon type.

11. A computer program product comprising a computer readable non-transitory storage medium containing program instructions, which program instructions when read by a processor, cause the processing circuitry to perform a method of controlling account logon rights of one or more computer systems based on multifactor authentication, the method comprising:
a) configuring respective logon rights control facilities of the one or more computer systems, to, at least, deny logon rights of a first account in, at least, a first logon type;
b) responsive to detecting, in a logon logging facility of a first computer systems of the one or more computer systems, an event of denying logon rights to the first account by the logon rights control facility,
wherein the detected event indicates an attempted logon to the first account, by a first user, using the first logon type:
initiating a sequence of authentication of the first user,
wherein the sequence of authentication utilizes a factor of authentication that is different from factors of authentication used in a logon attempt associated with the detected denying logon rights, thereby performing a multifactor authentication process; and
c) responsive to successful completion of the sequence of authentication, configuring the logon rights control facility of the first computer system to remove denial of logon rights to the first account in, at least, the first logon type.
